(19) United States
(12) Patent Application Publication
(10) Pub. No.: US 2005/0147151 A1
(43) Pub. Date: Jul. 7, 2005

(54) System and method for measuring temperature

(75) Inventors: Tsutomu Nakazawa, Isesaki-shi (JP); Motoya Sakano, Toyama-shi (JP)

Correspondence Address: WATCHSTONE P + D, 1300 EYE STREET, NW, SUITE 400 EAST, WASHINGTON, DC, 20005, US

(73) Assignee: Sanyo Electric Co., Ltd., Moriguchi-City (JP)

(21) Appl. No.: 10/948,788

(22) Filed: Sep. 24, 2004

Related U.S. Application Data
(63) Continuation-in-part of application No. PCT/JP03/03437, filed on Mar. 20, 2003.

(30) Foreign Application Priority Data
Sep. 29, 2003 (JP) 2003-338859

(51) Int. Cl. G01K 7/00

(52) U.S. Cl. 374/120

(57) ABSTRACT

A temperature measuring system includes, e.g., a temperature measuring pad configured to measure a temperature of an object on which the temperature measuring pad is to be disposed, and a reader configured to read temperature information including the measured temperature and an ID code given to the temperature measuring pad. The temperature measuring pad includes, e.g., an antenna portion for receiving a radio wave emitted from the reader, an electric power generating portion for generating electric power from the radio wave received by the antenna portion, a temperature sensor for measuring the temperature of the object and an output portion for wirelessly outputting the temperature information, the output portion being operated by the electric power generated by the electric power generating portion. The reader includes, e.g., a radio wave supplying portion for supplying the radio wave toward the temperature measuring pad, a receiving portion for wirelessly receiving the temperature information from the temperature measuring pad, and a storing portion for storing the temperature information.

This application claims priority under 35 U.S.C.§119 to Japanese Patent Application No. P2003-338859 filed on Sep. 29, 2003, the entire disclosure of which is incorporated herein by reference in its entirety.

### CROSS REFERENCE TO RELATED APPLICATIONS

This is continuation-in-part of commonly assigned co-pending PCT application No. PCT/JP03/03437, filed on Mar. 20, 2003, designating the United States of America as one of designation countries and claiming the benefit of the filing date of Japanese Patent Application No. 2002-78049 filed on Mar. 20, 2002, the entire disclosures of which are incorporated herein by reference in their entireties.

### BACKGROUND OF THE INVENTION

1. Field of the Invention

The present invention relates to a system and method for measuring temperature of an object. More specifically, the preferred embodiments relate to systems and methods preferably used for measuring body temperatures of patients in hospitals.

### DESCRIPTION OF THE RELATED ART

The following description sets forth the inventor's knowledge of related art and problems therein and should not be construed as an admission of knowledge in the prior art.

For example, in hospitals, it is required for a nurse to measure body temperatures of patients to monitor their health status several times a day. In measuring the body temperatures, conventionally, mercury thermometers and/or electric thermometers have been generally used. Typically, such thermometers are delivered to respective patients to measure their body temperature. Often, the patients measure their respective body temperatures by themselves. Then, in common scenarios, a nurse reads respective body temperatures of the thermometers and writes down the measured values on a recording sheet and collects the thermometers. Thereafter, it is often necessary for a nurse to sterilize the collected thermometers and then input the measured results which were once written down on the sheet into a personal computer.

Typically, there were, among other problems, the following drawbacks in measuring patient's body temperatures in hospitals.

In most hospitals, in order to check the health condition of each patient, such as, e.g., that the body temperature of each patient will be measured at least three times a day, e.g., once in the morning, once at noon and once at night. In the case of using mercury thermometers, it takes a long time to complete the measurement. On the other hand, in the case of using prediction type electric thermometers, it is required to tightly fit the thermometer on a skin surface to obtain the equilibrium body temperature. Otherwise, the accuracy deteriorates.

The measured temperatures of all of the patients is recorded on a recording sheet with a pencil or the like together with necessary information connected with the measured temperatures, e.g., the patient's name and the measured date and time. Therefore, a nurse is required to complete the recoding operation in addition to the body temperature measuring operation, causing troublesome operations. Furthermore, as mentioned above, the nurse is further required to input the measured data into a computer using a keyboard, which further increases the burden of the nurse. On the other hand, for each patient, the body temperature measuring operation was also troublesome.

The description herein of advantages and disadvantages of various features, embodiments, methods, and apparatus disclosed in other publications is in no way intended to limit the present invention. For example, certain features of the preferred embodiments of the invention may be capable of overcoming certain disadvantages and/or providing certain advantages, such as, e.g., disadvantages and/or advantages discussed herein, while retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a temperature measuring system capable of easily and quickly measuring a temperature of an object.

Among other potential advantages, some embodiments can provide a temperature measuring system preferably employed by hospitals for measuring body temperatures of patients for clinical purposes.

Among other potential advantages, some embodiments can provide a method of measuring body temperature of a patient for clinical purposes.

According to a first aspect of a preferred embodiment of the present invention, a temperature measuring system, comprises:
a temperature measuring pad configured to measure a temperature of an object on which the temperature measuring pad is to be disposed; and
a reader configured to read temperature information including the measured temperature and an ID code given to the temperature measuring pad,
wherein the temperature measuring pad includes an antenna portion for receiving a radio wave emitted from the reader, an electric power generating portion for generating electric power from the radio wave received by the antenna portion, a temperature sensor for measuring the temperature of the object and an output portion for wirelessly outputting the temperature information, the output portion being operated by the electric power generated by the electric power generating portion, and
wherein the reader includes a radio wave supplying portion for supplying the radio wave toward the temperature measuring pad, a receiving portion for wirelessly receiving the temperature information from the temperature measuring pad, and a storing portion for storing the temperature information.

According to a second aspect of a preferred embodiment of the present invention, a temperature measuring system comprises:
a temperature measuring pad configured to acquire temperature information of an object on which the temperature measuring pad is to be disposed; and
a reader configured to receive said temperature information and an ID code given to the temperature measuring pad,
wherein the temperature measuring pad includes a temperature sensor for measuring the temperature of the object and an output portion for wirelessly outputting the temperature information, and
wherein the reader includes a receiving portion for wirelessly receiving the temperature information from the temperature measuring pad and a storing portion for storing the temperature information.

In some examples, the temperature measuring system can further comprise a personal computer for reading the temperature information from the reader, storing the read temperature information and processing the read temperature information.

In some examples, in the temperature measuring system, the personal computer can include a monitor for displaying the processed temperature information.

In some examples, in the temperature measuring system, it is preferable that the personal computer displays the processed temperature information on the monitor such that the measured temperatures of the object obtained during a certain period of time is displayed graphically, which can be, e.g., together with the ID code and measured times and dates.

In some examples, the temperature measuring system can further comprise an ID code rewriting device that rewrites the ID code stored in the temperature measuring pad.

In some examples, in the temperature measuring system, it is preferable that the reader includes a display portion for displaying the measured temperature.

In some examples, it is preferable that the temperature measuring pad includes a flexible sheet-like main body and an adhesive layer formed on a rear surface of the main body, and wherein the antenna portion, the electric generating portion, the temperature sensor and the output portion are embedded in the main body.

In some examples, the temperature measuring system can be preferably configured for measuring a body temperature of a patient for clinical purposes.

In some examples, in the temperature measuring system, it is preferable that the temperature measuring pad further includes an A/D converter for converting an analog signal from the temperature sensor into a digital signal, and wherein the digital signal is wirelessly outputted from the output portion via the antenna.

In some examples, in the temperature measuring system, the temperature measuring pad can further include a memory for storing the ID code.

In some examples, in the temperature measuring system, it is preferable that the memory is a rewritable memory.

In some examples, the reader can further include an alarm for making an alarm signal when the measured temperature exceeds a certain temperature.

In some examples, the reader can further include a memory for storing the temperature information.

In some examples, the reader can further include an external interface for transmitting the temperature information stored in the memory to an external personal computer.

According to a third aspect of a preferred embodiment of the present invention, a method for measuring body temperature of a patient, comprises:
adhering a temperature information transmitting portion to a skin surface of the patient;
supplying an electromagnetic wave toward the temperature information transmitting portion from a temperature information receiving portion;
generating electric power in the temperature information transmitting portion with the electromagnetic wave received by the temperature information transmitting portion;
sensing a body temperature of the patient by the temperature information transmitting portion;
wirelessly outputting information on the body temperature including an ID code given to the temperature information transmitting portion and measured date and time from the temperature information transmitting portion using the generated electric power;
wirelessly receiving the information by the temperature information receiving portion;
transferring the information from the temperature information receiving portion to a computer;
storing the transferred information in a storing portion of the computer;
processing the information stored in the storing portion of the computer by using the computer; and, in some embodiments:
graphically displaying the processed information on a screen of the computer such that the processed information including a body temperature history of the patient for a certain period of a time is displayed together with the ID code and the measured time and date.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a schematic view showing a temperature measuring system according to an embodiment of the present invention;

FIG. 2 is a block diagram of a reader (receiving portion) and that of an adhesive temperature measuring pad (transmitting portion) of the temperature measuring system;

FIG. 3A is a top view of the adhesive temperature measuring pad according to an embodiment of the present invention;

FIG. 3B is a cross-sectional view taken along the line 3-3 in FIG. 3B;

FIG. 4 is a flowchart of the operation of the system;

FIG. 5 is a block diagram of the reader (receiving portion) and that of a computer connected to the reader;

FIG. 6 is an example of data stored in the computer;

FIG. 7A is an organized data displayed on a screen of the computer;

FIG. 7B is a graph of the organized data displayed on the screen of the computer;

FIG. 8 shows a state in which an ID code of the adhesive temperature pad is being rewritten; and

FIG. 9 is a block diagram of the system shown in FIG. 8.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

A temperature measuring system according to an embodiment of the present invention will be explained with reference to the attached drawings. The following explanation will be directed to a temperature measuring system preferably used for measuring body temperatures of patients in hospitals. However, it should be understood that this temperature measuring system is not limited to the above and can also be applied to various applications required to measure surface temperature of an object in various industries.

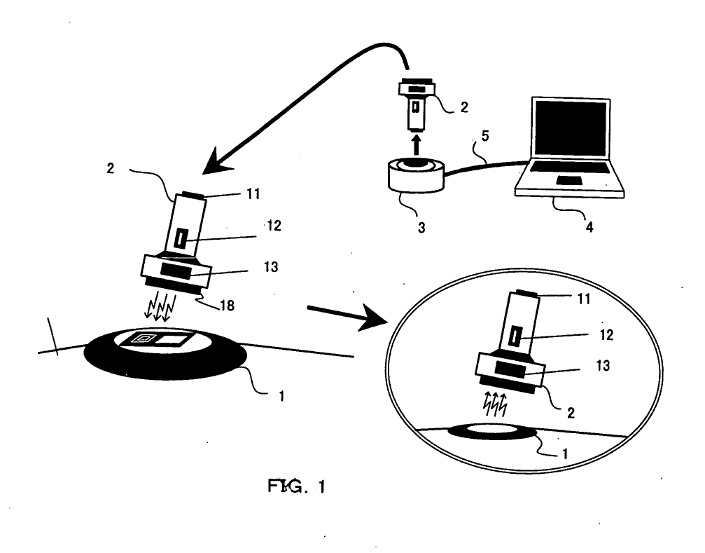

FIG. 1 depicts a schematic view showing an illustrative temperature measuring system of this embodiment. In FIG. 1, reference numeral “1” denotes an adhesive temperature measuring pad to be attached to a skin surface of a patient for measuring the body temperature. This adhesive temperature measuring pad 1 preferably forms a temperature information transmitting portion in this system. Reference numeral “2” denotes a reader for reading the temperature information from the adhesive temperature measuring pad 1 and storing the temperature information therein. This reader 2 preferably forms a temperature information receiving portion in this system. The reader 2 is preferably configured so as to be detachably plugged into a socket 3 having a charge function to be connected to the personal computer 4 via a cable 5 so that data processing can be performed by the personal computer 4.

In this embodiment, preferably the temperature measuring pad 1 attached to, e.g., a skin surface of a patient receives a radio wave R1 emitted from the reader 2 and generates electric power from the received radio wave R1 by itself, and measures the body temperature using the self-generated electric power. The measured temperature data will be transmitted as a radio wave R2 from the temperature measuring pad 1 to the reader 2 together with a given identification code (hereinafter referred to as “ID code”) of the temperature measuring pad 1, and then stored in the reader 2. After completing the temperature measurement, the reader 2 is preferably plugged into the socket 3 to be connected to the personal computer 4 via the cable 5. The personal computer 4 reads the temperature information from the reader 2 and can perform various data processing depending on need.

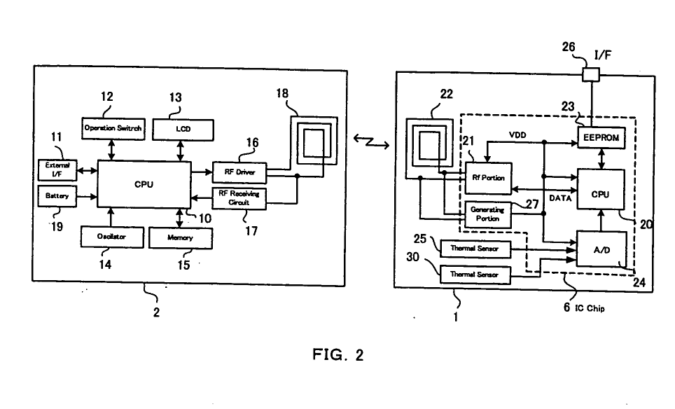

FIG. 2 shows a block diagram of the reader 2 and that of the adhesive temperature measuring pad 1 shown in FIG. 1.

As shown in the left side block diagram in FIG. 2, the reader 2 preferably includes a processor 10 (hereinafter referred to as “CPU”) for, e.g., entirely controlling the reader 2, an external interface 11 (hereinafter referred to as “I/F”) for, e.g., exchanging data between the reader 2 and an external personal computer 4, an operation switch 12 for, e.g., operating the reader 2, a liquid crystal display (LCD) 13, an oscillator 14 for a system clock and a clock function, a memory 15 for temporarily storing received data, an RF driver 16 including a resonant circuit, an RF receiving circuit 17, and antenna 18 for emitting a radio wave and receiving the temperature information from the adhesive temperature measuring pad 1.

On the other hand, as shown at the right side block diagram in FIG. 2, the adhesive temperature measuring pad 1 preferably includes an IC chip 6, a temperature sensor (e.g., a thermistor) 25, an antenna 22, an external interface I/F 26 and an external temperature sensor (e.g., a thermistor) 30. The aforementioned IC chip 6 preferably includes a CPU 20, an EEPROM 23 storing an ID code of the adhesive temperature measuring pad 1 and programs, an A/D converter (hereinafter simply referred to as “A/D”), an RF portion 21 and a power generation circuit 27 for generating electric power by rectifying the RF carriers of the radio wave received by the antenna 22.

In measuring the body temperature using the aforementioned system, as shown in FIG. 1, the reader 2 is preferably unplugged from the socket 3 by which the reader 2 was being charged. Then, the reader 2 is preferably brought close to the adhesive temperature measuring pad 1 attached to the skin surface of a patient R In this state, when the operation switch 12 is turned on, the reader 2 emits a 13.56 MHz weak radio wave R1 in the order of approximately 10 mW via the antenna 18 toward the adhesive temperature measuring pad 1. The adhesive temperature measuring pad 1 adhering to the skin surface of the patient P receives the radio wave and rectifies the RF carriers of the radio wave R1 to thereby generate electric power. The IC chip 6 embedded in the pad 1 capable of, e.g., being operated by the generated electric power measures the body temperature with the temperature sensor 25.

Preferably, the measured body temperature data is wirelessly transmitted with, e.g., a radio wave R2 together with the ID data of the adhesive temperature measuring pad 1 stored in the EEPROM 23 in the IC chip 6 via the RF portion 21 and the antenna 22.

The reader 2 preferably receives the radio wave R2 including the body temperature data wirelessly transmitted from the antenna 22 of the adhesive temperature measuring pad 1, and then converts the temperature data into digital data. The digitalized data of the body temperature information can be stored in the memory 15 with the time data related to the body temperature data. The reader 2 can have an alarm function that discriminates whether the body temperature exceeds a predetermined temperature and sounds an alarm when it is discriminated that the body temperature exceeds the predetermined temperature.

When the reader 2 is, e.g., plugged into the socket 3 connected to the personal computer 4 via the cable 5, the information including the body temperature and the ID code of the pad 1 and the measured date and time can be transmitted to the personal computer 4 via the cable 5, and then stored in a hard disk HDD. Thus, in such a manner, a series of operations for measuring body temperature, recording the body temperature and storing the temperature information may be completed.

In various examples, the temperature sensor 25 can be any means capable of converting a detected temperature into an electric resistance. Examples thereof include a thermistor chip and a thermistor pattern printed on a film-like substrate. Preferably, the temperature sensor 25 embedded in the measuring pad 1 directly or indirectly adheres to the skin surface of the patient P for a long time period. Accordingly, the actual and accurate body temperature can be quickly measured without requiring any prediction time which is usually required in a normal prediction type clinical thermometer. This remarkably reduces measurement errors.

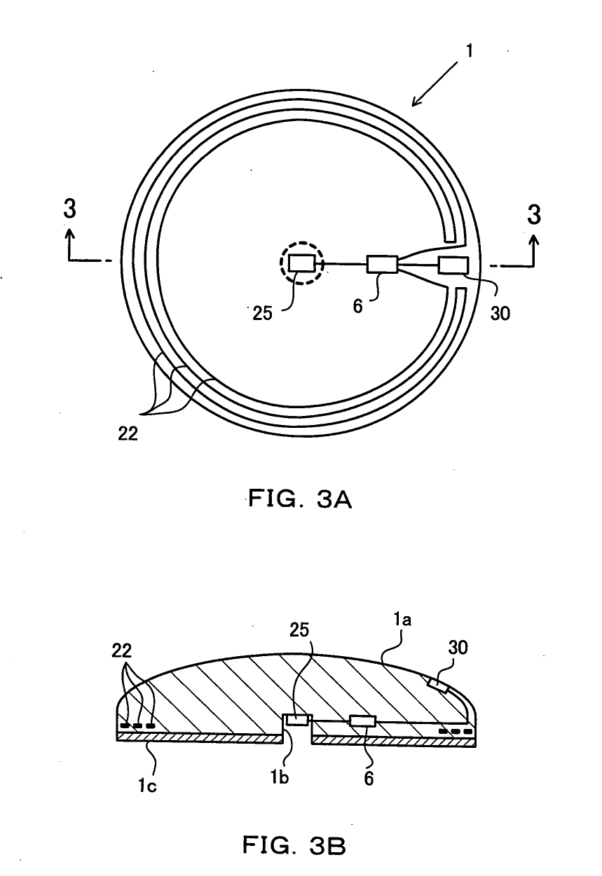

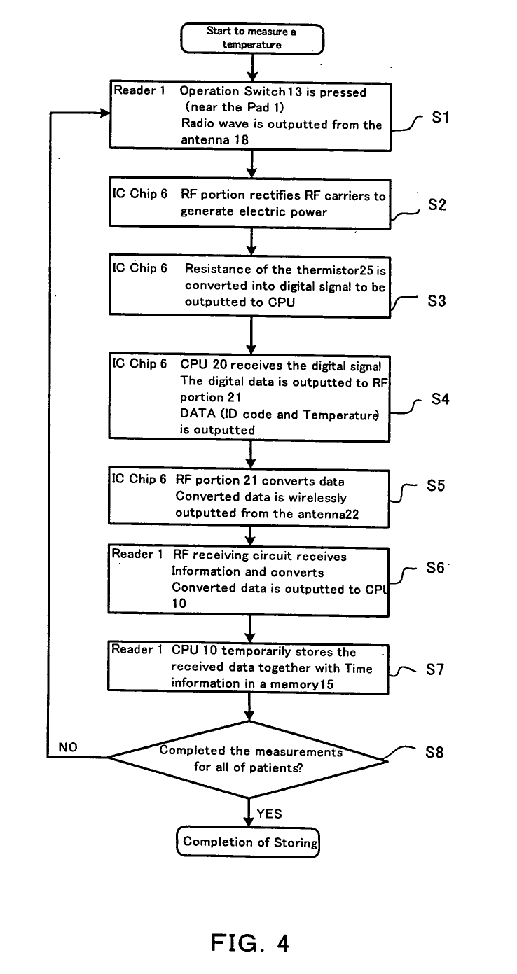

An illustrative example of the adhesive temperature measuring pad 1 is shown in FIG. 3. As shown in FIG. 3A, the pad 1 is preferably formed into a generally round disk shape. The main body 1a is made with, for example, polyurethane foam. The bottom surface in the central portion of the main body 1a is preferably provided with a dented portion 1b having a certain depth. In the bottom of this dented portion 1b, the thermistor chip 25 (e.g., a temperature sensor) is disposed so that the thermistor chip 25 can be isolated from the outside air. This thermistor chip 25 can, thus, detect indirectly the body temperature of the patient in the sate in which the pad 1 adheres to a skin surface of a patient. Since the thermistor chip 25 is thermally insulated from the external air, it becomes possible to measure the body temperature more accurately.

Preferably, also embedded in the main body 1a are an antenna 22 and the IC chip 6. The antenna 22 is formed into, e.g., a generally circular shape along the periphery of the main body 1a. The shape and the structure of the antenna 22 are not limited to the above, and can be any shape and structure. In the preferred embodiments, the pad 1 is further provided with an additional thermistor 30 for measuring an external temperature. This additional thermistor 30 is preferably arranged at the upper surface side of the main body 1a so as to be exposed to the external air. By considering the external temperature measured with this thermistor 30, the body temperature measured with the thermistor chip 25 can be amended so as to obtain accurate body temperatures of the patient. On the bottom surface of the main pad 1a, an adhesive layer 1b is formed so that the entire pad 1 can immovably adhere to a skin surface of a patient. In place of forming the aforementioned adhesive layer 1c, an adhesive tape (not shown) can be provided on the bottom surface of the main body 1a. Alternatively, any other means for adhering or attaching the pad 1 to a skin surface of a patient can be employed.

In the above-explained embodiment, although the adhesive temperature measuring pad 1 is formed into a round shape with a relatively large thickness, the structure of the adhesive temperature measuring pad 1 is not limited to the above. In place of the above, the structure disclosed in PCT/JP03/03437 and Unexamined Japanese Laid-open Patent Publication No. 2003-270051 can also be employed, and the disclosures thereof are incorporated herein by reference in their entireties, such incorporation being not merely in relation to the pad structure, but in relation to each and every aspect of such disclosures.

It should be understood that in this disclosure the wording of “pad” does not always mean a “relatively thick cushion-like member made of soft material” as shown in FIG. 3, but also means any other various members such as a sheet-like member, a film-like member, a patch-like member, a plate-like member or a belt-like member. Among other things, it is preferable that the temperature measuring pad 1 is a soft and flexible flattened member capable of fitting to a skin surface of a human body along a curvature thereof.

The preferred operation of this illustrative temperature measuring system will be explained based on the flowchart shown in FIG. 3. In this disclosure, “Step” may be simply referred to as “S.”

Initially, the operation switch 12 of the reader 2 is preferably turned on near the adhesive temperature measuring pad 1 to output a weak radio wave in the order of 10 mW generated in the RF driver 16 from the antenna 18 (Step S1).

Preferably, the radio wave is received by the antenna 22 of the adhesive temperature measuring pad 1 and introduced into the RF portion 21 of the IC chip 6. The RF portion 21 rectifies the RF carrier of the radio wave to generate the electric power, i.e., power-supply voltage VDD, which is supplied to the entire portion of the IC chip 6 (Step S2).

Preferably, the temperature sensor 25, or a thermistor 25 which varies in electric resistance in accordance with the body temperature of a human body, converts the electric resistance thereof into a voltage. The voltage is applied to the A/D converter 24 in which the voltage is converted into digital data, and then the digital data is outputted to the CPU 20 (Step S3).

The CPU 20 receives the digital data and makes a register store the data. The CPU 20 outputs digital data temporarily stored in the register to the RF portion 21 with the ID code previously written in the EEPROM 23 associated with the digital data (Step S4).

Preferably, the RF portion 21 converts the digital data into a wireless temperature data and then wirelessly outputs the temperature data via the antenna 22 (Step S5).

On the other hand, in the reader 2, the RF receiving circuit 17 preferably wirelessly receives the temperature data from the pad 1 via the antenna 18 and then converts the data into digitalized temperature data and outputs the data to the CPU 10 (Step S6).

The CPU 10 makes the memory 15 store the digitalized temperature data together with the current time information (Step S7).

Thus, the processing from the measurement of body temperature to the recordation of temperature information for a single person (e.g., patient) is completed. Then, it is discriminated whether processing for all persons (e.g., patients) is completed (Step S8).

If it is discriminated that processing for all persons (e.g., patients) is completed, the job terminates. To the contrary, if it is discriminated that processing for all persons (e.g., patients) is not completed, the routine returns to Step S1 to repeat the aforementioned steps from Step S1 to Step S8.

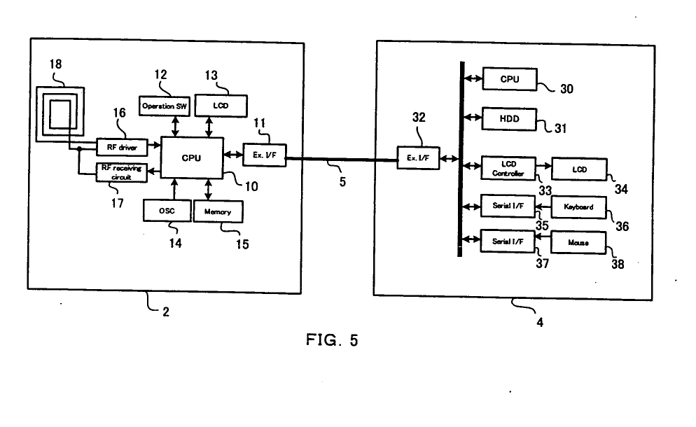

FIG. 5 shows a block diagram of the reader 2 and that of the computer 4 connected thereto via, e.g., a wire 5 in a state in which the reader 2 is plugged into the socket 3. Since the block diagram of the reader 2 is preferably substantially the same as that of the reader shown in FIG. 2, the explanation will be omitted by allotting the same reference numerals to the corresponding portions. In the right side block diagram showing the computer 4, reference numeral “30” denotes a CPU capable of executing an operation system (hereinafter referred to as “OS”), “31” denotes a hard disk (hereinafter referred to as “HDD”) capable of storing various application software and the data from the reader 2, “32” denotes an external I/F such as a USB port connected to the internal bus, “33” denotes an LCD controller, “34” denotes an LCD monitor, “35” denotes a serial I/F, “36” denotes a key board connected to the serial I/F 35, “37” denotes a serial I/F, “38” denotes a mouse connected to the serial I/F 37.

When the reader 2 is plugged into the socket 3 after the completion of measurements for all of the patients, the data stored in the memory 15 is transmitted from the external I/F 11 to be transferred to the personal computer 4 via the cable 5. In the personal computer 4, the data is received by the external I/F 32 and then transferred to the HDD 31. This HDD 31 stores the data (including, e.g., data of the ID of each patient, the body temperature, and the measured time and date).

In this embodiment, the data transfer from the reader 3 to the computer 4 is performed via the cable 5 (i.e., a cable communication). In place of such a cable communication for the data transfer, another method, such as, e.g., a known wireless communication method can be employed.

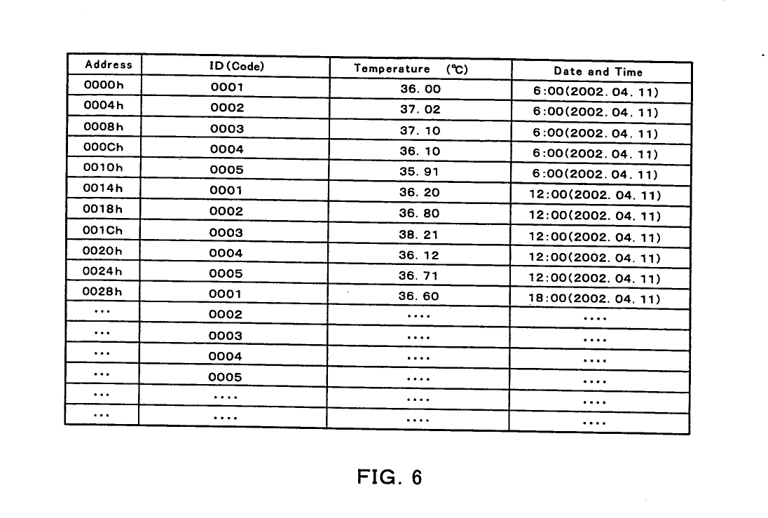

FIG. 6 shows the temperature information data stored in the HDD 31. The data can be, e.g., contained within a database including the data of the ID code, the measured body temperature and the measured time and date stored in this order for every patient. The data contained in this database can be utilized using application software capable of being operated by the CPU 30.

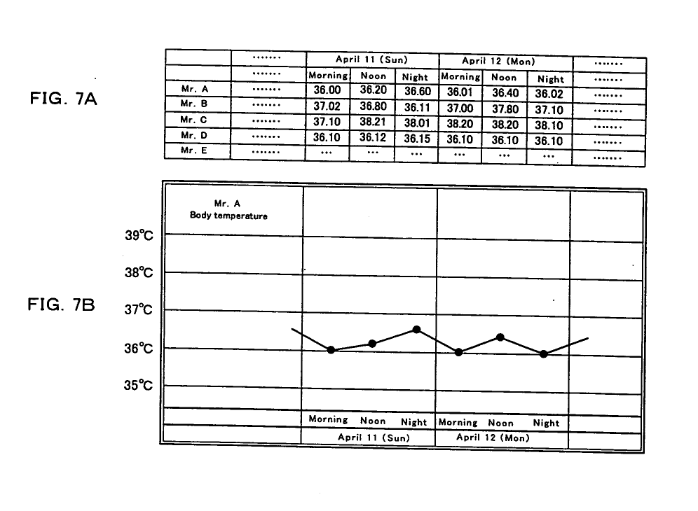

An illustrative example of utilizing the database is shown in FIGS. 7A-7B. In this regard, FIG. 7A shows a table displayed on the monitor of the computer 4 in which, by way of example, a two-day-history of the body temperatures of each patient measured three times a day is displayed. This history can also or alternatively be displayed as a graph shown in FIG. 7B, for example. The graph can be displayed, e.g., as a unit such as a one-day-history, a three-day-history, or a one-week-history, which is useful for a nurse or other caretaker to easily and visually grasp the status of each patient.

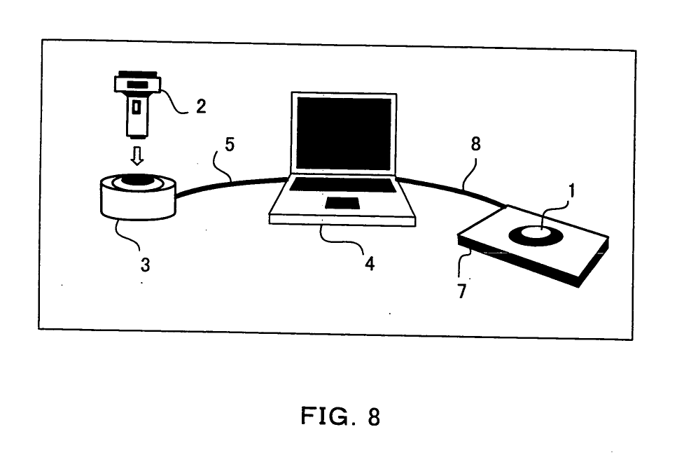

As mentioned above, the aforementioned adhesive temperature measuring pad 1 preferably stores an ID code given to each pad 1 which is also preferably exclusively used for a certain patient. Therefore, each ID code preferably corresponds to a respective patient. In cases where the pad 1 is used by another patient, the ID code should preferably be changed. Accordingly, in some embodiments, as shown in FIG. 8, the system further includes, e.g., an ID rewriting table 7 for rewriting the ID code of each pad 1 stored in the EEPROM 23. The rewriting table 7 is connected to the personal computer 4 via a cable 8.

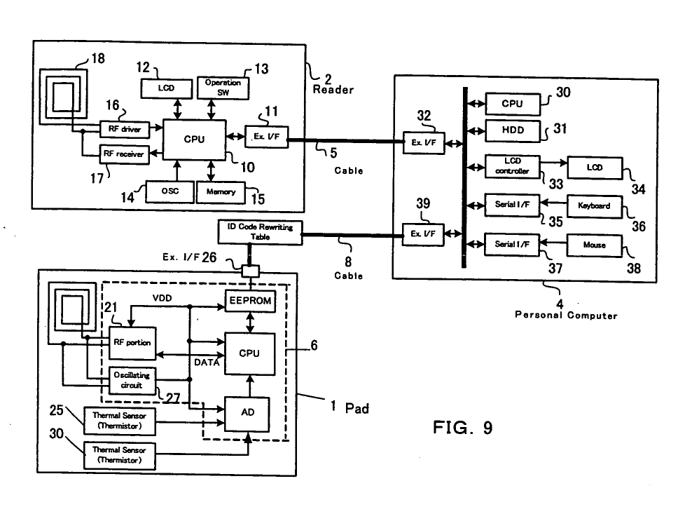

In rewriting the ID code of the pad 1, the pad 1 can be disposed on the table 7 with the external I/F 26 of the pad 1 connected to the table 7, and then the rewriting table 7 is preferably operated by the personal computer 4. Thus, the ID code stored in the EEPROM 23 of the pad 1 can be easily rewritten. The block diagram showing the connected status is shown in FIG. 9. Since the structures thereof are preferably substantially the same as that shown in FIG. 1, a detailed explanation of this block diagram will be omitted by allotting the same reference numerals to the corresponding portions.

In the aforementioned embodiment, the electric power for driving the IC chip 6 of the pad 1 is preferably generated by rectifying the RF carriers of the radio wave emitted from the reader 6 and received by the pad 1. In other embodiments of the present invention, however, another power source, such as, e.g., a battery (not shown), can be used for driving the IC chip 6.

Furthermore, although the temperature measuring system in the aforementioned embodiment is used for the clinical purposes in hospitals, the system can also be applied to various fields for measuring temperature, such as, e.g., for measuring a surface temperature of an object.

Concepts, features and specific embodiments of a temperature measuring device and method disclosed in PCT/JP03/03437, filed on Mar. 20, 2003, can also be applied to the temperature measuring system and method according to the present invention, and therefore the entire disclosure thereof is incorporated herein by reference in its entirety.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” is meant as an non-specific, general reference and may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

1. A temperature measuring system, comprising:
a temperature measuring pad configured to measure a temperature of an object on which the temperature measuring pad is to be disposed; and
a reader configured to read temperature information including the measured temperature and an ID code given to the temperature measuring pad,
wherein the temperature measuring pad includes an antenna portion for receiving a radio wave emitted from the reader, an electric power generating portion for generating electric power from the radio wave received by the antenna portion, a temperature sensor for measuring the temperature of the object and an output portion for wirelessly outputting the temperature information, the output portion being operated by the electric power generated by the electric power generating portion, and
wherein the reader includes a radio wave supplying portion for supplying the radio wave toward the temperature measuring pad, a receiving portion for wirelessly receiving the temperature information from the temperature measuring pad, and a storing portion for storing the temperature information.

2. The temperature measuring system as recited in claim 1, further comprising a personal computer for reading the temperature information from the reader, storing the read temperature information and processing the read temperature information.

3. The temperature measuring system as recited in claim 2, wherein the personal computer includes a monitor for displaying the processed temperature information.

4. The temperature measuring system as recited in claim 3, wherein the personal computer displays the processed temperature information on the monitor such that the measured temperatures of the object obtained during a certain period of time is displayed graphically together with the ID code and measured times and dates.

5. The temperature measuring system as recited in claim 1, further comprising an ID code rewriting device that rewrites the ID code stored in the temperature measuring pad.

6. The temperature measuring system as recited in claim 1, wherein the reader includes a display portion for displaying the measured temperature.

7. The temperature measuring system as recited in claim 1, wherein the temperature measuring pad includes a flexible sheet-like main body and an adhesive layer formed on a rear surface of the main body, and wherein the antenna portion, the electric generating portion, the temperature sensor and the output portion are embedded in the main body.

8. The temperature measuring system as recited in claim 1, wherein the system is configured for measuring a body temperature of a patient for clinical purposes.

9. The temperature measuring system as recited in claim 1, wherein the temperature measuring pad further includes an A/D converter for converting an analog signal from the temperature sensor into a digital signal, and wherein the digital signal is wirelessly outputted from the output portion via the antenna.

10. The temperature measuring system as recited in claim 1, wherein the temperature measuring pad further includes a memory for storing the ID code.

11. The temperature measuring system as recited in claim 10, wherein the memory is a rewritable memory.

12. The temperature measuring system as recited in claim 1, wherein the reader further includes an alarm for making an alarm signal when the measured temperature exceeds a certain temperature.

13. The temperature measuring system as recited in claim 1, wherein the reader further includes a memory for storing the temperature information.

14. The temperature measuring system as recited in claim 13, wherein the reader further includes an external interface for transmitting the temperature information stored in the memory to an external personal computer.

15. The temperature measuring system as recited in claim 1, further comprising:
a personal computer for reading the temperature information from the reader, storing the read temperature information and processing the read temperature information: and
an ID code rewriting device for rewriting the ID code,
wherein the personal computer displays the processed temperature information on a monitor such that the measured temperatures of the object obtained during a certain period of time is displayed graphically together with the ID data and the measured times and dates.

16. The temperature measuring system as recited in claim 15, wherein the system is used for measuring a body temperature of a patient for clinical purposes.

17. A temperature measuring system, comprising:
a temperature measuring pad configured to acquire temperature information of an object on which the temperature measuring pad is to be disposed; and
a reader configured to receive said temperature information and an ID code given to the temperature measuring pad,
wherein the temperature measuring pad includes a temperature sensor for measuring the temperature of the object and an output portion for wirelessly outputting the temperature information, and
wherein the reader includes a receiving portion for wirelessly receiving the temperature information from the temperature measuring pad and a storing portion for storing the temperature information.

18. The temperature measuring system as recited in claim 17, further comprising a personal computer for reading the temperature information from the reader, storing the read temperature information and processing the read temperature information.

19. The temperature measuring system as recited in claim 18, wherein the personal computer includes a monitor for displaying the processed temperature information.

20. The temperature measuring system as recited in claim 19, wherein the personal computer displays the processed temperature information on the monitor such that the measured temperatures of the object obtained during a certain period of time is displayed graphically.

21. The temperature measuring system as recited in claim 17, further comprising an ID code rewriting device that rewrites the ID code stored in the temperature measuring pad.

22. The temperature measuring system as recited in claim 17, wherein the reader includes a display portion for displaying the measured temperature.

23. The temperature measuring system as recited in claim 17, wherein the temperature measuring pad includes a flexible sheet-like main body and an adhesive layer formed on a rear surface of the main body, and wherein a power source, the temperature sensor and the output portion are embedded in the main body.

24. The temperature measuring system as recited in claim 17, wherein the system is configured for measuring a body temperature of a patient for clinical purposes.

25. The temperature measuring system as recited in claim 17, wherein the temperature measuring pad further includes an A/D converter for converting an analog signal from the temperature sensor into a digital signal, and wherein the digital signal is wirelessly outputted from the output portion.

26. The temperature measuring system as recited in claim 17, wherein the temperature measuring pad further includes a memory for storing the ID code.

27. The temperature measuring system as recited in claim 26, wherein the memory is a rewritable memory.

28. The temperature measuring system as recited in claim 17, wherein the reader further includes an alarm for making an alarm signal when the measured temperature exceeds a certain temperature.

29. The temperature measuring system as recited in claim 17, wherein the reader further includes a memory for storing the temperature information.

30. The temperature measuring system as recited in claim 29, wherein the reader further includes an external interface for transmitting the temperature information stored in the memory to an external personal computer.

31. The temperature measuring system as recited in claim 17, further comprising:
a personal computer for reading the temperature information from the reader, storing the read temperature information and processing the read temperature information: and
an ID code rewriting device for rewriting the ID code,
wherein the personal computer displays the processed temperature information on a monitor such that the measured temperatures of the object obtained during a certain period of time is displayed graphically.

32. The temperature measuring system as recited in claim 31, wherein the system is configured for measuring a body temperature of a patient for clinical purposes.

33. A method for measuring body temperature of a patient, the method comprising:
adhering a temperature information transmitting portion to a skin surface of a patient;
supplying an electromagnetic wave toward the temperature information transmitting portion from a temperature information receiving portion;
generating electric power in the temperature information transmitting portion with the electromagnetic wave received by the temperature information transmitting portion;
sensing a body temperature of the patient by the temperature information transmitting portion;
wirelessly outputting information on the body temperature including an ID code given to the temperature information transmitting portion and measured date and time from the temperature information transmitting portion using the generated electric power;
wirelessly receiving the information by the temperature information receiving portion;
transferring the information from the temperature information receiving portion to a computer;
storing the transferred information in a storing portion of the computer;
processing the information stored in the storing portion of the computer by using the computer.

34. The method of claim 33, further including graphically displaying the processed information on a screen of the computer such that the processed information including a body temperature history of the patient for a certain period of a time is displayed.

35. The method of claim 34, further including displaying the body temperature history together with the ID code and the measured time and date.
